(19) United States
(12) Patent Application Publication
(10) Pub. No.: US 2024/0279854 A1
(43) Pub. Date: Aug. 22, 2024

(54) BLENDED PADDING

(71) Applicant: Moririn Co., Ltd., Ichinomiya-shi (JP)

(72) Inventors: Koji TOMINAGA, Nagoya-shi (JP); Yoshimasa HASHIDA, Nagoya-shi (JP); Mikiya HIROCHO, Nagoya-shi (JP); Tatsuya MIHARA, Masuda-shi (JP)

(73) Assignee: Moririn Co., Ltd., Ichinomiya-shi (JP)

(21) Appl. No.: 18/418,810

(22) Filed: Jan. 22, 2024

(30) Foreign Application Priority Data
Feb. 17, 2023 (JP) 2023-023165

(51) Int. Cl. D04H 1/4382; D04H 1/4258; D04H 1/435; D04H 1/4391; D04H 1/55

(52) U.S. Cl. CPC D04H 1/43835; D04H 1/4258; D04H 1/435; D04H 1/43918; D04H 1/55; D10B 2401/02; D10B 2501/00; D10B 2503/06

(57) ABSTRACT

The blended padding of the present disclosure includes a polyester fiber and a water-repellent regenerated cellulose fiber treated in a specific manner. The water-repellent regenerated cellulose fiber contains, for example, a water-repellent rayon, and the polyester fiber contains, for example, at least one fiber selected from the group consisting of a polyethylene terephthalate (PET) fiber, a polytrimethylene terephthalate (PTT) fiber, a polybutylene terephthalate (PBT) fiber, a polyethylene naphthalate (PEN) fiber, a polylactic acid (PLA) fiber, a polycaprolactone (PCL) fiber, and a polybutylene succinate (PBS) fiber.

### TECHNICAL FIELD

The present disclosure relates to a blended padding which can be used as a padding material such as a down jacket, a down coat, a quilt, a pillow, or the like.

### BACKGROUND ART

For padding used in garments such as down, high outstanding heat retaining property is required, and a well-known method is to increase a bulk property (bulkiness and bulk elasticity) of the padding and use the heat insulation property provided by air. On the other hand, when the inside of a garment warms up and the body starts sweating, humidity becomes high, making the garment uncomfortable to wear. Therefore, it is necessary to adjust the humidity inside the garment so that it does not become too high. One of the methods to solve both of these problems is, for example, to use natural fibers such as down, which have excellent bulkiness and moisture absorbing property. However, since down is a natural product obtained from plumose of a goose, its cost is high and mass production of down has limitations. In addition, from the viewpoint of animal welfare, down is getting harder to obtain in recent years.

On the other hand, as a substitute for down, a padding material, which is made from a synthetic fiber and has down-like feel, has been developed (such as Patent Documents 1-3). Such padding material includes a polyester fiber and a regenerated cellulose fiber (such as rayon).

### PRIOR ART DOCUMENTS

### Patent Documents

Patent Document 1: Japanese Unexamined Patent Publication No. 2016-67452
Patent Document 2: Japanese Unexamined Patent Publication No. 2014-9408
Patent Document 3: Japanese Unexamined Patent Publication No. 2010-532827

### SUMMARY OF THE INVENTION

### Means for Solving the Problem

The blended padding of the present disclosure is a blended a polyester fiber and a water-repellent padding including regenerated cellulose fiber, the water-repellent regenerated cellulose fiber includes a compound containing at least one acidic group selected from the group consisting of a carboxyl group and a sulfonic acid group, a fiber surface is bonded with a cross-linking agent and a hydrocarbon-based water repellent containing a polymer having (meth)acrylic ester as a basic unit of a monomer, and the polyester fiber and the water-repellent regenerated cellulose fiber are included in a mass ratio of 30:70 to 90:10. Furthermore, the present disclosure provides a padding material for clothing or bedding, including the blended padding. The present disclosure provides a padding material for clothing or bedding, which is internally filled with the blended padding.

### BRIEF DESCRIPTION OF THE DRAWINGS

FIGS. 1A to 1C are views illustrating one embodiment of a method for manufacturing a blended fiber ball in the blended padding of the present disclosure.

FIGS. 2A to 2C are views illustrating one embodiment of a method for manufacturing a nonwoven sheet in the blended padding of the present disclosure.

FIG. 3 is a graph showing results of moisture content measurement performed in Reference Example 1.

FIG. 4 is a graph showing results of moisture absorption measurement performed in Reference Example 2.

FIG. 5 is a graph showing results of evaluating a bulkiness of the blended fiber balls obtained in Examples 1 and 2 and Comparative Examples 1 and 2.

FIG. 6 is a graph showing results of evaluating a bulkiness after recovery after repeatedly applying a load to the blended fiber balls obtained in Examples 1 and 2 and Comparative Examples 1 and 2.

FIG. 7 is a graph showing results of calculating specific volumes of the sheet-like blended paddings obtained in Example 3 and Comparative Examples 4 to 6.

FIG. 8 is a graph showing results of calculating compression ratios of the sheet-like blended paddings obtained in Example 3 and Comparative Examples 4 to 6.

FIG. 9 is a graph showing results of moisture absorption measurement for the sheet-like blended paddings obtained in Example 3 and Comparative Examples 4 to 7.

### EMBODIMENTS FOR CARRYING OUT THE INVENTION

The regenerated cellulose fiber described in Patent Document 1 has high moisture absorbing property, but on the other hand, the more it is washed, the more the bulkiness of the padding gradually decreases and the heat retaining property gradually decreases. Therefore, it is necessary to reduce the influence of washing by lowering a blending ratio of the regenerated cellulose fiber. If the blending ratio of the regenerated cellulose fiber is too low, the moisture absorbing property becomes insufficient and the wadding will not be suitable for clothing.

In Patent Document 2, a hydrophobic treatment is performed to obtain a hydrophobicized moisture-absorbing heat generating fiber that repels water and maintains moisture-absorption and heat generation even when it contacts with liquid phase moisture such as excessive perspiration or rain. As a hydrophobizing agent, fluorine-containing compounds and silicone compounds are disclosed. However, fluorine-containing compounds have recently been strictly regulated from an environmental standpoint and are therefore not preferred. Furthermore, when using the above-mentioned hydrophobizing agent, the fiber must undergo a fixing process called curing set (also called curing) involving a high-temperature heat treatment, which causes problems such as discoloration and deterioration of the fiber and an increase in work steps. In addition, the use of silicone compounds tends to increase the slippage between fibers. This may result in poor shape stability after washing when it is made into the shape of wadding. In Patent Document 3, silicone oil is used as a finishing agent for the purpose of obtaining bulkiness of the padding. However, including Patent Document 2, sufficient washing durability may not be obtained simply by processing a cellulose fiber or the like with silicone oil or the like.

To provide a blended padding that maintains a good bulk property even after washing and has a high moisture absorbing property, the inventors considered making a blended padding containing a polyester fiber and a regenerated cellulose fiber.

The inventors have studied to provide a blended padding that maintains a good bulk property even after washing and has a high moisture absorbing property and have found that by including a polyester fiber and a predetermined water-repellent regenerated cellulose fiber, it is possible to provide a blended padding that achieves the above effects.

The blended padding according to the present disclosure contains a polyester fiber and a predetermined water-repellent regenerated cellulose fiber, as described above.

The polyester fiber has excellent elasticity and a softness similar to feathers. The polyester fiber includes, but is not limited to, for example, aromatic polyesters such as polyethylene terephthalate (PET) fiber, polytrimethylene terephthalate (PTT) fiber, polybutylene terephthalate (PBT) fiber and polyethylene naphthalate fiber (PEN), and aliphatic polyesters such as polylactic acid fiber (PLA), polycaprolactone fiber (PCL) and polybutylene succinate fiber (PBS). Copolymer components may be used to the extent that performance is not compromised, and titanium dioxide may be added as a matting agent or UV shielding material. Any single fiber made of these resins and composite fibers combining two or more types are acceptable.

Other copolymer components include, for example, polyhydriccarboxylic acids such as isophthalic acid, orthophthalic acid, naphthalene dicarboxylic acid, paraphenylene dicarboxylic acid, trimellitic acid, pyromellitic acid, succinic acid, glutaric acid, adipic acid, suberic acid, azelaic acid, sebacic acid and dodecanedioic acid and their derivatives; dicarboxylic acids including sulfonates such as 5-sodium sulfoisophthalic acid and 5-sodium dihydroxyethyl sulfoisophthalate and their derivatives; and ethylene glycol ether such as 1,2-propanediol, 1,3-propanediol, 1,4-butanediol, 1,6-hexanediol, neopentyl glycol, 1,4-cyclohexanedimethanol, diethylene glycol, polyethylene glycol, trimethylolpropane, pentaerythritol, 4-hydroxybenzoic acid, ε-caprolactone, and bisphenol A.

A fineness and a fiber length of the polyester fiber are not limited. For example, the fineness of the polyester fiber is preferably 0.5 dtex or more and 20 dtex or less, more preferably 0.8 dtex or more and 15 dtex or less, and even more preferably 1.0 dtex or more and 10 dtex or less. When the polyester fiber having such a fineness is used, both excellent bulkiness and softness can be obtained. The fineness (dtex (decitex)) is a unit of a fiber thickness and indicates the number of grams per 10,000 meters of the fiber. A higher fineness value indicates a thicker fiber.

A fiber length of the polyester fiber is, for example, preferably 5 mm or more and 200 mm or less, more preferably 12 mm or more and 100 mm or less, and even more preferably 15 mm or more and 80 mm or less. When the blended padding containing the water-repellent regenerated cellulose fiber is a blended fiber ball, for example, it is preferably 5 mm or more and 64 mm or less, more preferably 8 mm or more and 51 mm or less, and even more preferably 12 mm or more and 38 mm or less. In the case of a blended padding sheet or an opened fiber, for example, it is preferably 5 mm or more and 100 mm or less, more preferably 15 mm or more and 80 mm or less, and even more preferably 30 mm or more and 80 mm or less. When the polyester fiber having such a fiber length is used, the fiber is well organized, and the shape of the padding tends to be less likely to collapse.

The polyester fiber may be straight or crimped. The crimp may be naturally crimped, sterically crimped, or mechanically crimped. Furthermore, only one type of polyester fiber may be used alone, or in combination of two or more types. For example, polyester fibers having different fineness, different fiber lengths, and different melting points may be used in combination.

The water-repellent regenerated cellulose fiber is a fiber made by imparting water repellency to a regenerated cellulose fiber such as rayon, polynosic, cupra, and lyocell. Methods for imparting water repellency to the regenerated cellulose fiber include the following methods. First, a compound containing at least one acidic groups selected from the group consisting of a carboxyl group and a sulfonic acid group is added to the regenerated cellulose fiber. Next, on the surface of the regenerated cellulose fiber, a crosslinking agent and a hydrocarbon-based water repellent agent comprising a polymer having a (meth)acrylic acid ester as a basic monomer unit are bonded. In the description, “(meth)acrylic ester” means “acrylic ester” or “methacrylic ester”. In this way, the water-repellent regenerated cellulose fiber is obtained by imparting water repellency to a regenerated cellulose fiber. Such water-repellent regenerated cellulose fiber is disclosed, for example, in JP2019-065443A.

The water-repellent regenerated cellulose fiber contains a compound containing at least one acidic group selected from the group consisting of a carboxyl group and sulfonic acid group. The compound containing the carboxyl group is not limited, and for example, from the viewpoint of easily imparting the carboxyl group to the regenerated cellulose fiber, at least one selected from the group consisting of a polyacrylic acid and an acrylic acid-maleic acid copolymer is preferred. Compounds containing the sulfonic acid group is not limited, and include, for example, formalin condensation products of naphthalene sulfonate, polystyrene sulfonate, phenol sulfonate, dihydroxydiphenylsulfone, hydroxyphenylsulfone and the like.

Examples of methods for incorporating a compound containing at least one acidic group selected from the group consisting of the carboxyl group and the sulfonic acid group into the water-repellent regenerated cellulose fiber include the following methods (i) to (iii). Among them, kneading described in (i) is preferred because the compound containing the acidic group is uniformly mixed and dispersed throughout the surface and inside of the fiber, and that the compound containing the acidic group is difficult to fall off from the fiber.
(i) A method of kneading a compound containing an acidic group into a fiber by spinning a spinning viscose solution prepared by mixing a compound containing an acidic group with a viscose stock solution when producing a regenerated cellulose fiber.
(ii) A method of impregnating a fiber with a compound containing an acidic group by dipping a regenerated cellulose fiber in an aqueous solution or the like containing a compound containing an acidic group.
(iii) A method of attaching a compound containing an acidic group to a regenerated cellulose fiber by spraying or applying an aqueous solution or the like containing a compound containing an acidic group to the regenerated cellulose fiber.

As polyacrylic acid, for example, an unneutralized form of polyacrylic acid, that is, an H-type polyacrylic acid in which the carboxyl group of the polyacrylic acid is H-type may be used, the one in which the part that the carboxyl group of the polyacrylic acid is H-type is substituted with a metal ion such as Na or an ionic compound may be used, or the one containing both may be used. Examples of the polyacrylic acid include compounds having a structure in which the carboxyl group is bonded to the main chain mainly and the contribution of the carboxyl group to the molecular weight of the polymer is largest. Specifically, the polyacrylic acid having a theoretical carboxyl group content of 72 g/mol or more is preferably used as the polyacrylic acid.

Examples of the acrylic acid-maleic acid copolymer include the polymers shown in (i) and (ii) below.
(i) A polymer of an ethylenically unsaturated monomer containing at least one selected from the group consisting of acrylic acid and acrylic acid salts (hereinafter sometimes referred to as an “acrylic acid monomer”) and an ethylenically unsaturated monomer containing at least one selected from the group consisting of maleic acid, maleic acid salts, and maleic anhydride (hereinafter sometimes referred to as a “maleic acid monomer”).
(ii) A polymer of an ethylenically unsaturated monomer containing at least one selected from the group consisting of acrylic acid and acrylic acid salts and at least one selected from the group consisting of maleic acid, maleic acid salts and maleic anhydride.

The acrylic acid-maleic acid copolymer is preferably a polymer of the ethylenically unsaturated monomer containing at least one selected from the group consisting of acrylic acid and acrylic acid salts and the ethylenically unsaturated monomer containing at least one selected from the group consisting of maleic acid and maleic acid salts, or a polymer of the ethylenically unsaturated monomers containing at least one selected from the group consisting of acrylic acid and acrylates, and at least one selected from the group consisting of maleic acid and salts, from the viewpoint of easy imparting the carboxyl group to the fiber. If necessary, the acrylic acid-maleic acid polymer may be copolymerized with other monomers than the acrylic acid and maleic acid monomers to the extent that the effect of the present disclosure is not impaired. The other monomers may be, for example, an unsaturated monocarboxylic acid monomer.

A weight average molecular weight of the acrylic acid-maleic acid copolymer is preferably 5,000 or more and 500,000 or less, more preferably 6,000 or more and 250,000 or less, even more preferably 10,000 or more and 100,000 or less, and 30,000 or more and 80,000 or less. When the weight average molecular weight is within the above range, it can be easily kneaded into the regenerated cellulose. Furthermore, even when it is dyed or washed, compounds containing the carboxyl group are less likely to fall off or be denatured.

The acrylic acid-maleic acid copolymer preferably contains 5% by mass or more and 95% by mass or less, more preferably 20% by mass or more and 80% by mass or less, even more preferably 30% by mass or more and 70% by mass or less, and particularly preferably 40% by mass or more and 60% by mass or less of maleic acid. When the content of maleic acid in the acrylic acid-maleic acid copolymer is within the above range, it is easy to impart the carboxyl group to the regenerated cellulose fiber.

In the present disclosure, a maleic acid ratio in the acrylic acid-maleic acid copolymer can be measured and calculated as follows, assuming that organic components in the acrylic acid-maleic acid copolymer are only acrylic acid and maleic acid.
(1) Placing approximately 4 to 5 mL of a sample (aqueous solution containing the acrylic acid-maleic acid copolymer salt) into a glass vial, and heating and drying it at 110° C. for 20 hours.
(2) Dissolving approximately 50 mg of the dried sample in approximately 0.7 mL of heavy water.
(3) Performing a 1H-NMR analysis on the heavy water solution of the sample by using an FT-NMR device (JMTC-300/54/SS, manufactured by JEOL Ltd.), and determining a composition ratio of the acrylic acid component (A) and the maleic acid component (M) from an abundance ratio of methylene group carbon and methine group carbon in the polymer main chain. The number of measurements is 16, and an average value is calculated.

In the water-repellent regenerated cellulose fiber, a content of the compound containing at least one acidic group selected from the group consisting of the carboxyl group and the sulfonic acid group is preferably, for example, 1 part by mass or more and 35 parts by mass or less, more preferably 3 parts by mass or more and 30 parts by mass or less, and even more preferably 5 parts by mass or more and 25 parts by mass or less relative to 100 parts by mass of cellulose. If the content of the compound containing the acidic group is 1 part by mass or more and 35 parts by mass or less relative to 100 parts by mass of cellulose, the effect of the acidic group is more easily exerted. Moreover, since a fiber strength is less likely to decrease, the fiber is easily to be finer. In other words, the effects of the acidic group and the finely fibrillating process can be exerted in a better balance.

In the water-repellent regenerated cellulose fiber, a total amount of at least one acidic group selected from the group consisting of the carboxyl group and the sulfonic acid group is preferably 0.3 mmol/g or more and 1.6 mmol/g or less, more preferably 0.35 mmol/g or more and 1.5 mmol/g or less, even more preferably 0.4 mmol/g or more and 1.4 mmol/g or less. When the total amount of at least one acidic group selected from the group consisting of the carboxyl group and the sulfonic acid group is within the range described above, the effect of the acidic group is more easily exerted. In the water-repellent regenerated cellulose fiber, as described above, the acidic group is bonded with an isocyanate compound, and a fixing property of the water-repellent agent on the fiber surface can be improved even when the fiber surface is heated to a low temperature of 40° C. or higher and 110° C. or lower. Therefore, the water-repellent regenerated cellulose fiber having an appropriate moisture content and an improved moisture absorbing property can be obtained. As a result, it is presumed that the regenerated cellulose fiber and the polyester fiber constituting the blended padding will maintain their bulk properties during washing, especially during repeated washing, as excessive entanglement of the fibers is suppressed. Furthermore, since the heat treatment is performed at a low temperature, it is presumed that discoloration and deterioration of the fibers are suppressed. In the present disclosure, the total amount of at least one acidic group selected from the group consisting of the carboxyl group and the sulfonic acid group is measured and calculated as described below.

### (Measurement of the Total Amount of the Carboxyl Group)

(1) 1.2 g of a sample was immersed in 50 mL of 1 mol/L hydrochloric acid aqueous solution (pH 0.1), stirred and left for 5 minutes. The aqueous solution was then stirred again to adjust the pH of the aqueous solution to 2.5. As a result, all the carboxyl group in the sample (fiber) exist as H-type. Next, the sample was washed with water and dried at 105° C. for 2 hours in a constant-temperature blower dryer to be an absolute dry state. By washing the sample in water, all excess hydrochloric acid adhering to the fiber is removed.
(2) 100 mL of ion-exchanged water, 0.4 g of sodium chloride, and 20 mL of 0.1 mol/L sodium hydroxide solution were placed in a beaker.
(3) Approximately 1 g of the sample prepared in (1) was precisely weighed, and the mass of the precisely weighed sample was defined as W1 g. It was cut into pieces until it was small enough not to wrap around a stirrer, placed in the beaker prepared in (2), and stirred for 15 minutes with a stirrer. As a result, all carboxyl group in the sample (fiber) are converted into salt forms. The stirred sample was filtered by suction. 60 mL of the filtrate was taken and titrated with 0.1 mol/L hydrochloric acid aqueous solution by using phenolphthalein as an indicator, and a titration amount was defined as X1 (mL).
   (4) The total amount of the carboxyl group, Y (mmol/g), was calculated based on the following formula. Thus, the amount of sodium hydroxide obtained by subtracting the remaining amount of sodium hydroxide from the total amount of sodium hydroxide corresponds to the total amount of the carboxyl group in the sample (fiber).

Total amount of carboxyl group Y (mmol/g)=[(0.1×20)−(0.1×X1)]×(120/60)]/W1

Isocyanate compounds can be listed as a crosslinking agent. Examples of the isocyanate compounds include compounds having an isocyanate group and compounds having a blocked isocyanate group.

Examples of the compounds having the isocyanate group include monoisocyanates such as butyl isocyanate, phenyl isocyanate, tolyl isocyanate and naphthalene isocyanate, diisocyanates such as tolylene diisocyanate, diphenylmethane diisocyanate, tetramethylxylylene diisocyanate, diisocyanates such as hydrogenated diphenylmethane diisocyanate, and trimer which is their isocyanurate rings, and trimethylolpropane adduct.

Examples of the compounds having the blocked isocyanate group include compounds obtained by protecting an isocyanate group of the above compound having the isocyanate group with a blocking agent. Examples of the blocking agents used at this time include organic blocking agents such as secondary or tertiary alcohols, active methylene compounds, phenols, oximes, and lactams, and bisulfites such as sodium bisulfite and potassium bisulfite.

In the blocked isocyanate group, the highly reactive isocyanate group is masked, and the block usually does not dissociate unless it is heat-treated at a high temperature of 120° C. or higher and 180° C. or lower. However, in the present disclosure, cellulose has at least one acidic group selected from the group consisting of the carboxyl group and the sulfonic acid group. Therefore, it is presumed that the block dissociates even when the fiber surface is heat-treated at a low temperature of 40° C. or higher and 110° C. or lower. Therefore, the blocked isocyanate group exists in a dissociated state on the surface of the water-repellent regenerated cellulose fiber. Further, since the heat treatment is performed at a low temperature, discoloration and deterioration of the fiber are suppressed.

The amount of the isocyanate compound attached is, for example, preferably 0.01 parts by mass or more and 5 parts by mass or less, more preferably 0.02 parts by mass or more and 3 parts by mass or less, even more preferably 0.03 parts by mass or more and 2 parts by mass or less, and even further preferably 0.05 parts by mass or more and 1 part by mass or less relative to 100 parts by mass of cellulose. When the amount of the isocyanate compound attached is within the above range, the durability of water repellency (hereinafter sometimes referred to as “durable water repellency”) will be better, and the fiber is less likely to become rigid. The isocyanate compounds may be used alone or in combination of two or more.

As a hydrocarbon-based water repellent including a polymer having the (meth)acrylic ester as a basic monomer unit, for example, the number of carbon atoms of the hydrocarbon group present via an ester bond is preferably 12 or more. The number of carbon atoms of the hydrocarbon group is more preferably 24 or less, and even more preferably 21 or less. The hydrocarbon group may be linear or branched, saturated or unsaturated hydrocarbon, and may even have an alicyclic or aromatic ring. Among these, those that are linear are preferable, and those that are linear alkyl groups are more preferable.

The (meth)acrylic ester monomer is preferably 80% by mass or more and 100% by mass or less relative to the total monomer units constituting the polymer. The weight average molecular weight of the hydrocarbon-based water repellent is preferably 100,000 or more, and more preferably 500,000 or more. The hydrocarbon-based water repellent may be a copolymer of acrylic ester and methacrylic ester.

The hydrocarbon-based water repellent can be used as a water repellent composition in which hydrocarbon-based water repellent particles are dispersed in water. The water repellent composition may contain surfactants and organic solvents. As such a water repellent composition, for example, a commercially available product such as NEOSEED NR series (manufactured by NICCA CHEMICAL CO., LTD.) may be used.

In the water-repellent regenerated cellulose fiber, for example, the amount of the hydrocarbon-based water repellent adhered is preferably 0.1 parts by mass or more and 10 parts by mass or less, more preferably 0.2 parts by mass or more and 8 parts by mass or less, further preferably 0.3 parts by mass or more and 6 parts by mass or less, and even more preferably 0.5 parts by mass or more and 2 parts by mass or less relative to 100 parts by mass of cellulose. When the amount of the hydrocarbon-based water repellent adhered is within the above range, the washing durable water repellency will become better, and the fiber will be less likely to become rigid. Moreover, a water-repellent regenerated cellulose fiber exhibiting an appropriate moisture content can be obtained. The hydrocarbon-based water repellent may be used alone or in combination of two or more.

A mass ratio of the hydrocarbon-based water repellent to the isocyanate compound (hydrocarbon-based water repellent: isocyanate compound) is not limited. For example, from the viewpoint of improving water repellency and washing durability, the ratio is preferably 1:1 or more and 7:1 or less, and more preferably 2:1 or more and 6:1 or less.

In the water-repellent regenerated cellulose fiber, the moisture content after washing five times, as measured by the method described below, is preferably 50% or more and 70% or less. It is more preferably 55% or more and 65% or less. When the moisture content after washing satisfies a predetermined range, the regenerated cellulose fiber and/or the regenerated cellulose fiber and the polyester fiber are less likely to tangle with each other and a crimping of the regenerated cellulose fiber is maintained when washing is repeated. Due to these reasons, bulkiness tends to be less likely to decrease.

(Moisture Content after Washing)

An opened fiber was prepared by opening each fiber, and approximately 5 g of each was weighed as a sample. After each sample was placed in a net and washed by using a C4M method in accordance with JIS L 1930, a mass of the sample was immediately measured. The mass of the sample is defined as Ww. After the measurement, the sample was hung to dry completely, and the mass of the sample was measured. The mass of the sample is defined as Wd. From the obtained Ww and Wd, the moisture content was calculated by using the following formula (I). This washing was performed 5 times.

$$Moisture content ( \% ) = \{ Ww - Wd \times ( 1 + ( official moisture content / 100 ) ) \} / \{ Wd \times ( 1 + ( official moisture content / 100 ) ) \} \qquad ( I )$$

In the water-repellent regenerated cellulose fiber, a moisture absorption measured by the following method is preferably 15% or more and 40% or less. It is more preferably 20% or more and 35% or less. A high degree of moisture absorbing property can be obtained when the moisture absorption satisfies the predetermined range.

### (Moisture Absorption)

An opened fiber was prepared by opening each fiber, and approximately 2.5 g of the obtained opened fiber was spread into a sheet shape of approximately 10 cm in length and width to prepare a sample. A mass of the obtained sample in an absolute dry state was measured. This mass is defined as W0. Then, the sample was left at rest for 24 hours at 40° C. under a condition of 90% RH to absorb moisture. Thereafter, the sample that had absorbed moisture was left at rest for 24 hours at 20° C. under a condition of 60% RH to release moisture. The mass was measured 1, 3, 5, 7, and 24 hours after the start of moisture absorption, and 1, 3, 5, 7, and 24 hours after the start of moisture release. This mass is defined as W. From the obtained W0 and W, the moisture absorption (moisture content) was calculated by using the following formula (II).

$$Moisture absorption ( \% ) = \{ ( W - W 0 ) / W 0 \} \times 100 \qquad ( II )$$

In the present disclosure, it is preferable to use a water-repellent regenerated cellulose fiber that satisfies both the moisture content moisture absorption after washing. A commercially available water-repellent regenerated cellulose fiber may be used. As the water-repellent regenerated cellulose fiber, for example, water-repellent rayon “Eco Repellas (registered trademark)” commercially available from Daiwabo Rayon Co., Ltd. can be listed.

A fineness and a fiber length of the water-repellent regenerated cellulose fiber are not limited. The fineness of the water-repellent regenerated cellulose fiber is, for example, preferably 0.3 dtex or more and 20 dtex or less, more preferably 0.5 dtex or more and 7 dtex or less, and even more preferably 0.7 dtex or more and 4 dtex or less. When a water-repellent regenerated cellulose fiber having such fineness are used, both excellent bulkiness and softness can be achieved.

The fiber length of the water-repellent regenerated cellulose fiber is, for example, preferably 5 mm or more and 200 mm or less, more preferably 12 mm or more and 100 mm or less, and even more preferably 15 mm or more and 80 mm or less. When a blended padding containing the water-repellent regenerated cellulose fiber is a blended fiber ball, for example, it is preferably 5 mm or more and 64 mm or less, more preferably 8 mm or more and 51 mm or less, and even more preferably 12 mm or more and 38 mm or less. In the case of a blended padding sheet or an opened fiber, for example, it is preferably 5 mm or more and 100 mm or less, more preferably 15 mm or more and 80 mm or less, and even more preferably 30 mm or more and 80 mm or less. When a polyester fiber having such fiber length is used, the fiber tends to have excellent cohesion, and the shape of the padding tends to be less likely to collapse.

The water-repellent regenerated cellulose fiber may be linear or crimped. The crimp may be naturally crimped or mechanically crimped. Furthermore, only one type of water-repellent regenerated cellulose fiber may be used, or two or more types may be used in combination. For example, as the water-repellent regenerated cellulose fiber, a water-repellent regenerated cellulose fiber having different fineness, a water-repellent regenerated cellulose fiber having different fiber lengths, and the like may be used in combination.

A blending ratio of the polyester fiber and the water-repellent regenerated cellulose fiber includes the polyester fiber and the water-repellent regenerated cellulose fiber in a mass ratio of 30:70 to 90:10. The blending ratio is preferably a mass ratio of 50:50 to 85:15, more preferably 60:40 to 80:20. By containing a polyester fiber and a water-repellent regenerated cellulose fiber in such a blending ratio, excellent bulkiness can be maintained even after washing, and further excellent moisture absorption can be exhibited.

The blended padding according to the present disclosure may contain other fibers in addition to the polyester fiber and the water-repellent regenerated cellulose fiber, as long as the effects of the present disclosure are not impaired. The other fibers may be any fibers and may include various functional fibers. Examples of such various functional fibers include chemical fibers having functions such as heat insulation, heat storage, antibacterial, deodorizing, mite-proof, and antistatic functions.

A form of a blended padding according to the present disclosure includes a blended fiber ball, a blended padding sheet (such as a nonwoven fabric sheet, or a web-type sheet) or an opened fiber (teared wadding). Examples of the nonwoven fabric sheet include a chemical-bonded sheet obtained by a chemical bonding method in which fibers are linked to each other with a resin; a thermal-bonded sheet in which low melting point fibers are mixed and melted by heat and bonded; a needle punched sheet obtained by a needle punching method in which fibers are entangled with each other by a needle; and a water flow interlacing sheet obtained by a spun lacing method in which fibers are entangled with each other by a stream of water instead of a needle, or the like.

When the blended padding according to the present disclosure, in the form of a blended fiber ball, is washed by a C4M method in accordance with JIS L 1930, a ratio (FP1/FP0) of a fill power (FP1) after washing once to a fill power (FP0) of unwashed blended fiber ball is preferably 76% or more, more preferably 78% or more, particularly preferably 79% or more, and most preferably 80% or more. When FP1/FP0 is within such a numerical range, sufficient bulkiness is maintained even after washing, and good heat retention is obtained. This is a characteristic that cannot be obtained with a common cellulose fiber. The upper limit of FP1/FP0 is not limited, and for example, it may be 90% or less, 85% or less, or 81% or less. A specific method for calculating the fill power is as described in Example below.

Furthermore, a ratio (FP10/FP0) of a fill power (FP10) after washing ten times to the fill power (FP0) of the unwashed blended fiber ball is preferably 75% or more. It is more preferably 70% or more, and even more preferably 65% or more. When FP10/FP0 is within such a numerical range, sufficient bulkiness is maintained even after repeated washing, and better heat retention is obtained. The upper limit value of FP10/FP0 is not limited, and for example, it may be 68% or less.

When the blended padding according to the present disclosure, in the form of a blended padding sheet, is washed by the C4M method in accordance with JIS L 1930, a specific volume after washing ten times measured by the measuring method described below is preferably 75 cm³/g or more. Furthermore, it is more preferably 76 cm³/g or more and 100 cm³/g or less, and particularly preferably 78 cm³/g or more and 90 cm³/g or less. When the specific volume is within such a numerical range, the bulkiness is maintained even after washing, and good heat retention can be obtained. The specific method for calculating it is as described in Examples below.

When the blended padding according to the present disclosure is washed by the C4M method in accordance with JIS L 1930, in the case of a blended padding sheet, a compression ratio after washing ten times measured by the measuring method described below is preferably 32% or more. It is more preferably 35% or more, even more preferably 36% or more, and most preferably 37% or more. Furthermore, it is preferably 45% or less, and more preferably 40% or less. When the compression ratio is within this numerical range, the bulk property (bulk elasticity) of the blended padding sheet is maintained even after repeated washing, and it provides heat retention as well as a soft and comfortable wearing feeling.

### (Compression Ratio)

First, four blended padding sheets (with a thickness of 12 mm) each having a square shape of 20 cm on a side are stacked, and a PET thick plate (with a thickness of 0.7 mm, a weight of 33 g) having a square shape of 20 cm on a side is placed on top of the sheets and leave it at rest for 30 seconds. Thereafter, the heights of the four corners with the thick plate placed thereon are measured, and an average value Ha is calculated. Subsequently, a weight of 500 g is placed on the thick plate and leave it at rest for 30 seconds. Thereafter, the heights of the four corners with the thick plate and the weight placed thereon are measured, and an average value Hb is calculated. From the calculated average values Ha and Hb, a compression ratio is determined by using the following formula (III)′.

$$Compression ratio ( \% ) = \{ ( Ha - Hb ) / Ha \} \times 100 \qquad {( III )}^{′}$$

When the blended padding according to the present disclosure is washed by the C4M method in accordance with JIS L 1930, in the form of a blended padding sheet, a ratio of a compression ratio (H1) after washing once to a compression ratio (H0) of the unwashed blended padding sheet is preferably 80% or more, more preferably 82% or more, and most preferably 85% or more. When H1/H0 is within such a numerical range, even when the blended padding sheet after washing is used under load conditions, good bulkiness is maintained, and good heat retention is obtained. This is a characteristic that cannot be obtained with a common cellulose fiber. This is presumed to be due to the fact that in a regenerated cellulose fiber in which water repellency is not imparted, the fiber becomes entangled with each other even after one wash, and the bulkiness as a blended padding sheet is lost. The upper limit value of H1/H0 is not limited, and for example, it may be 94% or less.

When the blended padding according to the present disclosure is washed by the C4M method in accordance with JIS L 1930, in the form of a blended padding sheet, a ratio of a compression ratio (H10) after washing ten times to the compression ratio (H0) of the unwashed blended padding sheet is preferably 55% or more. It is more preferably 60% or more and most preferably 65% or more. If H10/H0 is within such a numerical range, sufficient bulkiness is maintained even after repeated washing, and better heat retention is obtained. The upper limit of H10/H0 is not limited, for example, it may be 78% or less.

In the blended padding according to the present disclosure, the moisture absorption calculated by the following formula (II)′ is preferably 3% or more. The moisture absorption is more preferably 4% or more, and most preferably 5% or more. A preferable upper limit of the moisture absorption is 28%, a more preferable upper limit of the moisture absorption is 22%, and a most preferable upper limit of the moisture absorption is 16%. If the moisture absorption is within this range, the moisture absorption and heat generation properties will be satisfactorily exhibited. Particularly, in the present disclosure, it is possible to achieve both bulk property and moisture absorbing property compared to general rayon or conventional blended padding containing a cellulose fiber subjected to water-repellent treatment. The upper limit of the moisture absorption is not particularly limited, and it is better when it is closer to 22% in the case of only the water-repellent regenerated cellulose fiber of the present disclosure.

$$Moisture absorption ( \% ) = \{ ( W 1 - W 0 ) / W 0 \} \times 100 \qquad {( II )}^{′}$$

W0: Mass of blended padding in an absolute dry state.
W1: Mass of at least one of the blended paddings after being left at rest for 1 hour and 7 hours at 40° C. and 90% RH.

As described above, the blended padding according to the present disclosure maintains good bulk property after washing, and also has an excellent moisture absorption property. In particular, the blended padding according to the present disclosure is characterized in maintaining good bulk property even after repeated washing.

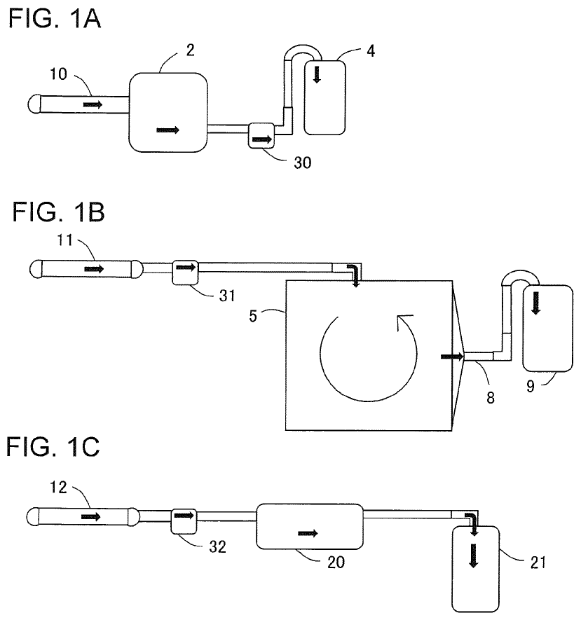

Then, one embodiment of a method for manufacturing a blended padding according to the present disclosure is described based on FIGS. 1A to 1C. FIGS. 1A to 1C illustrate one embodiment of the method for manufacturing a blended fiber ball in the blended padding according to the present disclosure.

### (i) Step for Opening (FIG. 1A)

Raw fibers are transferred to a card machine 2 through a feed lattice 10, and then the raw fibers are opened to arrange fibers in parallel to each other to produce a web (a fiber layer having a length and a width). The web is stored in an opened fiber storage chamber 4 by a wadding transfer means 30 (a blower, or the like). This step is carried out separately for each of a polyester fiber and a water-repellent regenerated cellulose fiber.

### (ii) Step for Fiber Blending (FIG. 1B)

First, preliminary opened and weighed predetermined amounts of a polyester fiber and a water-repellent regenerated cellulose fiber are each transferred from a feed lattice 11 to a wadding storage room 5 by a wadding transfer means 31 (e.g., a blower). In the wadding storage room 5, the polyester fiber and the water-repellent regenerated cellulose fiber are agitated and mixed by an air blower (not shown). In this way, a blended wadding in which the polyester fiber and the water-repellent regenerated cellulose fiber are homogeneously mixed is obtained, and thus a blending ratio variation is reduced.

The blended wadding is discharged by suction from the wadding storage room 5 in a horizontal direction. That is, a suction port 8 is provided at a side of the wadding storage room 5, and the suction port 8 has an aperture which is getting wider from the bottom of the wadding storage room 5 toward the upper side. Thus, the fiber wadding is sucked uniformly from the side of the wadding storage room 5. The wadding sucked from the wadding storage room 5 is transferred to a blended wadding storage chamber 9 by wadding transfer means (not shown) and is stored temporarily.

### (iii) Step for Producing Fiber Ball (FIG. 1C)

Wadding took out from the blended wadding storage chamber 9 is spread on a feed lattice 12 and is transferred to a balling machine 20 by a wadding transfer means 32 (a blower, or the like). Then, a fiber ball is produced using the balling machine 20, and the obtained fiber ball is transferred to a storage chamber 21 to be accommodated. Examples of the balling machine 20 used include a balling machine manufactured by HAI JIN MACHINERY CO. LTD. or Changsh HITEC Machinery Co. Ltd. Any balling machine can be used as long as it is suitable for producing a fiber ball, and it is not limited to these. Further, without providing the blended wadding storage chamber 9, wadding sucked from the wadding storage room 5 can be supplied directly to the balling machine 20. The blended fiber ball obtained in this way preferably has a diameter of 1 mm or more and 30 mm or less, and more preferably of 5 mm or more and 20 mm or less.

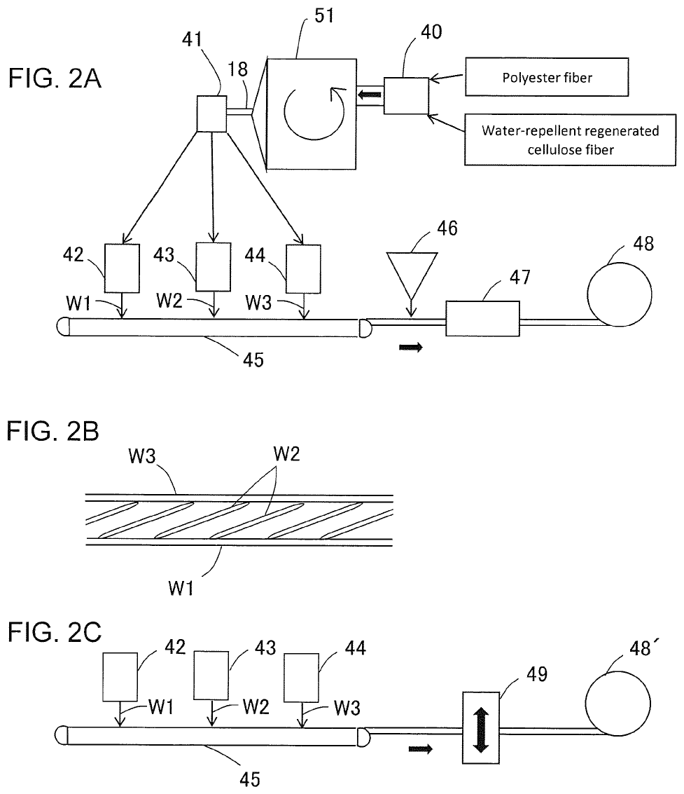

Then, one embodiment of another method for manufacturing a blended padding according to the present disclosure will be described based on FIGS. 2A to 2C. FIGS. 2A to 2C are explanatory views showing one embodiment of a method for manufacturing a nonwoven fabric sheet in a blended padding according to the present disclosure. FIG. 2A shows a process for manufacturing a blended padding by a chemical bonding method. FIG. 2B shows a method for laminating opened webs. FIG. 2C shows a part of a process for manufacturing a blended padding by a needle punch method.

As shown in FIG. 2A, a polyester fiber and a water-repellent regenerated cellulose fiber opened by an opening machine (not shown) are each transferred to a weighing machine 40 and weighed to obtain a predetermined amount, and then transferred to a wadding storage room 51. The wadding storage room 51 has almost the same structure and function as those of the above-described wadding storage room 5. The separately transferred polyester fiber and water-repellent regenerated cellulose fiber are homogeneously agitated and mixed by an air blowing means.

Then, the mixed polyester fiber and water-repellent regenerated cellulose fiber (the blended wadding) is transferred from the wadding storage room 51 to a fiber transferring blower 41 through a suction port 18. A predetermined amount of the blended wadding is supplied to each of the three roller card machines 42, 43 and 44 from the fiber transferring blower 41. In the roller card machines 42, 43, and 44, the blended waddings are opened to arrange fibers in parallel to each other to produce webs W1, W2, and W3. Each of the webs W1, W2, and W3 is stacked on a feed lattice 45.

FIG. 2B is a lateral view of the stacked structure of webs W1, W2, and W3. As shown in FIG. 2B, the web W2 in the middle is transferred to a width direction of the feed lattice 45 (i.e., in a direction perpendicular to the web discharge direction), folded at lateral ends of the feed lattice 45 and partially overlapped. Thus, fibers of the web W2 are evenly directed toward a width direction of the sheet. As a result, a strength of the sheet is enhanced in the width direction of the sheet. Webs W1 and W3 are evenly directed toward a longitudinal direction of the sheet (i.e., a transfer direction of the feed lattice 45). The webs W1, W2, and W3 may be stacked in the same direction (for example, in a longitudinal direction or a width direction orthogonal to the longitudinal direction) as required.

As described above, the blended wadding stacked on the feed lattice 45 in a sheet form is continuously transferred to a resin sprayer 46, and a resin is sprayed from a resin sprayer 46. Then, the resultant is dried in a dryer 47, and wound to obtain a chemical-bonded nonwoven fabric sheet 48. Instead of the resin sprayer 46, a dipping device may be used to soak the blended wadding in the resin liquid and dry it.

As examples of a resin used, urethane resin-based adhesive can be used mainly, and an amount of the resin sprayed is preferably 0.1 parts by mass or more and 2.0 parts by mass or less, and more preferably 0.5 parts by mass or more and 1.0 parts by mass or less relative to 100 parts by mass of the blended wadding. Instead of an adhesive, a low-melting point polyester fiber may be used, for example as a part of the polyester fiber. By using such a low-melting point polyester fiber, the low-melting point polyester fiber is melted by heating the blended wadding stacked in a sheet form and serves as a substitute for the adhesive.

In a process for manufacturing a blended padding by a needle punching method, a step for stacking the webs W1, W2, and W3 in a sheet form is substantially the same as the process for manufacturing the blended padding by the chemical bonding method as shown in FIGS. 2A and 2B, and thus the detailed explanation is omitted. As shown in FIG. 2C, a blended wadding stacked on the feed lattice 45 in a sheet form is continuously transferred to a needle punching machine 49. Then, fibers are entangled by a needle which moves up-and-down so as to penetrate the sheet to obtain a nonwoven fabric sheet 48′.

A blended padding of the present disclosure can be in a form of a web-type sheet in addition to a fiber ball and a nonwoven fabric sheet. The web-type sheet can be obtained by stacking the polyester fiber and the water-repellent regenerated cellulose fiber, which are homogeneously agitated and mixed in a wadding storage room 51, in FIG. 2A, with webs W1, W2, and W3, which are opened by roller card machines 42, 43, and 44, on a feed lattice 45 The webs W1, W2, and W3 can be stacked, without limitation, in a structure shown in FIG. 2B. Further, the number of the roller card machines are not limited to 3, and it can be a plural number of two or more.

A blended padding of the present disclosure has a uniform performance, and thus is used as a substitute for down, for a padding material for clothing such as a cold weather protection jacket or a coat, for bedding such as a quilt or a pillow, and furthermore for a padding material for a floor cushion or a cushion.

### EXAMPLES

Although the present disclosure is specifically described below with reference to following Examples and Comparative Examples, the present disclosure is not limited to the following Examples.

### Reference Example 1

First, moisture contents of a polyester fiber (PET fiber), a general rayon, and a water-repellent regenerated cellulose fiber after washing were measured. The PET fiber (manufactured by Toray Industries, Inc., raw fiber product number T22, solid) sterically crimped having a fineness of 2.2 dtex and a fiber length of 64 mm was used. The general rayon (manufactured by Daiwabo Rayon Co., Ltd.) having a fineness of 1.7 dtex and a fiber length of 29 mm, and naturally crimped was used. As the water-repellent regenerated cellulose fiber, a water-repellent rayon (naturally crimped) having a fineness of 1.7 dtex prepared by the following method was made to a fiber length of 40 mm and used.

### (Production of a Water-Repellent Rayon Fiber)

### [Preparation of Viscose Liquid for Spinning]

A viscose liquid for spinning was prepared by adding an aqueous solution of acrylic acid-maleic acid copolymer salt to a raw material viscose (including 8.5% by mass of cellulose, 5.7% by mass of sodium hydroxide and 2.8% by mass of carbon disulfide) so that the acrylic acid-maleic acid copolymer salt was 12% by mass relative to 100% by mass of cellulose, and stirring and mixing it by using a mixer. The temperature was kept at 20° C. As the aqueous solution of acrylic acid-maleic acid copolymer salt, “Aqualic TL400” manufactured by Nippon Shokubai Co., Ltd. was used. The aqualic TL400 is an aqueous solution containing 40% by mass of sodium acrylic acid-maleic acid copolymer with a weight average molecular weight of 50,000, and has a viscosity of 1990 mPa·s, and a content of maleic acid in the sodium acrylic acid-maleic acid copolymer is 45% by mass.

### [Spinning Process]

The obtained viscose liquid for spinning was spun by a two-bath tension spinning method at a spinning speed of 60 m/min and a drawing rate of 50% to obtain a viscose rayon yarn having a fineness of 1.7 dtex. As the first bath (spinning bath), a Mueller bath (50° C.) including 100 g/L of sulfuric acid, 15 g/L of zinc sulfate, and 350 g/L of sodium sulfate was used. A circular nozzle (a pore diameter of 0.06 mm, number of holes of 4000) was used as a spinneret for discharging viscose.

### [Scouring Process]

The obtained viscose rayon yarn was cut into fiber lengths of 40 mm, treated with hot water, washed with water, and desulfurized by showering with sodium hydrogen sulfide. The obtained treated fiber was washed again with water, bleached with sodium hypochlorite, pickled, and then washed with water. Thereafter, the fibers were squeezed by using a compression roller so that the moisture content was 130%.

### [Water Repellent Finishing]

First, a water repellent treatment liquid was obtained by mixing a hydrocarbon water repellent composition (Neoseed NR-158, manufactured by NICCA Chemical Co., Ltd.) used as a non-fluorine water repellent agent with a blocked isocyanate crosslinking agent (“NK Assist NY-30”, manufactured by NICCA Chemical Co., Ltd., solid content concentration: 40% by mass) as an isocyanate compound at a mass ratio of 3:1. Then, the fibers obtained above with a moisture content of 130% was immersed in the water repellent treatment solution (50° C.) for 30 seconds. A bath ratio of the fibers and the water-repellent treatment liquid was set to 1:10. Thereafter, the fibers were squeezed by using a compression roller so that an adhesion rate of the water repellent agent (solid content) to the fibers was 1% by mass. Then, it was dried for 10 minutes in a dryer set at 100° C. to obtain a water-repellent rayon fiber having a total amount of the carboxyl group of 0.76 mmol/g.

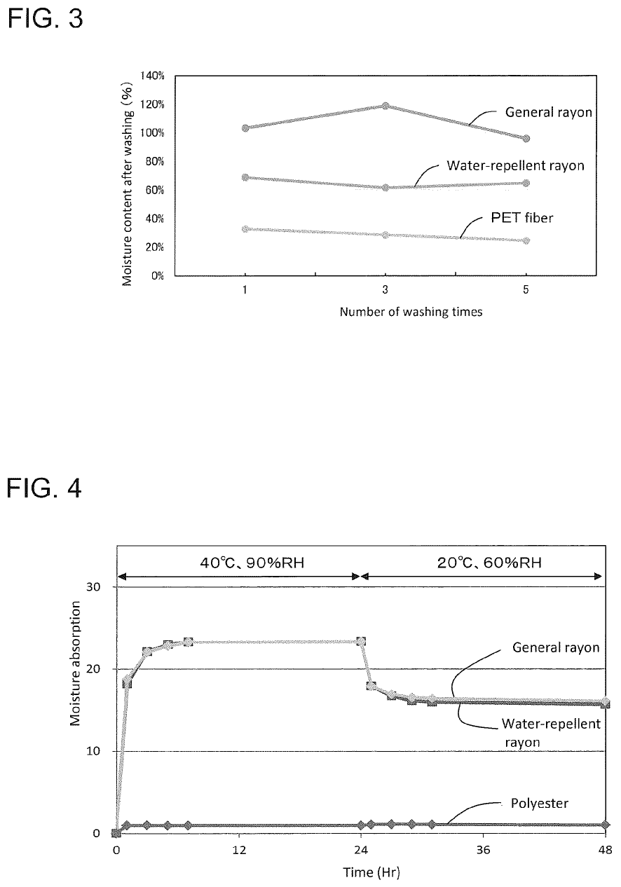

An opened fiber was prepared by opening each fiber, and approximately 5 g of each was weighed as a sample. After each sample was placed in a net and washed by using a C4M method in accordance with JIS L 1930, a mass of the sample was immediately measured. This mass is defined as Ww. After the measurement, the sample was hung to dry completely, and a mass of the sample was measured. This mass is defined as Wd. From the obtained Ww and Wd, the moisture content was calculated by using the above formula (I). This washing was performed 5 times. The results are shown in FIG. 3.

As shown in FIG. 3, the moisture content of the general rayon was high, the moisture content of the PET fiber was low, and the moisture content of the water-repellent rayon was between those of the general rayon and the PET fiber. When washed repeatedly, the water-repellent rayon had a smaller change in the moisture content than the general rayon, and the bulkiness of the water-repellent rayon raw fiber after washing was better than that of the general rayon raw fiber after washing.

### Reference Example 2

Moisture absorption properties of a general rayon, a water-repellent regenerated cellulose fiber (water-repellent rayon), and a polyester fiber were verified. The general rayon (manufactured by Daiwabo Rayon Co., Ltd.) having a fineness of 1.4 dtex and a fiber length of 38 mm, and naturally crimped was used. The water-repellent rayon described in Reference Example 1 (having a fineness of 1.7 dtex, a fiber length of 40 mm, naturally crimped) was used as a water-repellent rayon.

As in Reference Example 1, an opened fiber was prepared by opening each fiber, and approximately 2.5 g of the obtained opened fiber was spread into a sheet shape of approximately 10 cm in length and width as a sample. A mass of the obtained sample in an absolute dry state was measured. This mass is defined as W0. Then, the sample was left at rest for 24 hours at 40° C. under a condition of 90% RH to absorb moisture. Thereafter, the sample that had absorbed moisture was left at rest for 24 hours at 20° C. under a condition of 60% RH to release moisture. The mass was measured 1, 3, 5, 7, and 24 hours after the start of moisture absorption, and 1, 3, 5, 7, and 24 hours after the start of moisture release. This mass is defined as W. From the obtained W0 and W, the moisture absorption (moisture content) was calculated by using the above formula (II). The results are shown in FIG. 4.

As shown in FIG. 4, it was found that there was almost no difference in moisture absorption and release properties between the general rayon and the water-repellent rayon. It was found that the PET fiber does not have moisture absorption and release properties because the official moisture content of PET itself is 0.4% and it is difficult to absorb moisture.

### Example 1

A blended fiber ball containing a polyester fiber and a water-repellent regenerated cellulose fiber was prepared. As the polyester fiber, a polyethylene terephthalate (PET) fiber sterically crimped having a fineness of 3.3 dtex and a fiber length of 38 mm was used. As the water-repellent regenerated cellulose fiber, a water-repellent rayon (a fineness of 1.7 dtex, naturally crimped) prepared in the same manner as in Reference Example 1 except that the fiber length was 25 mm was used. Each fiber was individually passed through a card machine (DK-903 manufactured by Trutzschler) and opened.

The opened PET fiber was spread uniformly on the feed lattice 11. Then, the opened water-repellent rayon was placed on the PET fiber layer. The mass ratio of the PET fiber and the water-repellent rayon was set to be 70:30. Then, the resultant was put into a wadding storage room 5 (inner volume: 5 m³) as shown in FIG. 1B from the top by using a blower. Hereinafter, this operation was repeated, and the fiber in which the PET fiber and the water-repellent rayon were blended was stored in the wadding storage room 5 and stirred and mixed.

Next, the fiber was sucked in a horizontal direction from the wadding storage room 5, and a blended wadding including 70% by mass of the PET fiber and 30% by mass of the water-repellent rayon was obtained. This blended wadding was supplied to a ball machine 20, and a blended fiber ball having a diameter of 10 mm was obtained.

### Comparative Example 1

A blended fiber ball having a diameter of 10 mm was obtained in the same manner as in Example 1, except that a general rayon (manufactured by Daiwabo Rayon Co., Ltd., having a fineness of 1.7 dtex, a fiber length of 25 mm and naturally crimped) was used instead of the water-repellent rayon.

### Example 2

A blended fiber ball having a diameter of 10 mm was obtained in the same manner as in Example 1 except that a mass ratio of a PET fiber and a water-repellent rayon was 80:20.

### Comparative Example 2

A blended fiber ball having a diameter of 10 mm was obtained in the same manner as in Example 2, except that a general rayon (manufactured by Daiwabo Rayon Co., Ltd., having a fineness of 1.7 dtex, a fiber length of 25 mm and naturally crimped) was used instead of the water-repellent rayon.

### Comparative Example 3

A blended fiber ball having a diameter of 10 mm was obtained in the same manner as in Example 1 except that the water-repellent rayon was not used.

A fill power of the fiber balls obtained in Examples 1 and 2 and Comparative Examples 1 to 3 was measured. The fill power is a bulkiness in cubic inches when a constant load is applied to a sample.

### (Fill Power: FP)

30 g of a sample is placed in a cylinder having an internal diameter of 290 mm and a height of 600 mm. After placing it, it is left at rest for 60 seconds with a loading disk of 94.3 g put on it, and the fill power (in³/30 g) is calculated by reading a height at which the loading disk contacts the blended fiber ball in the cylinder.

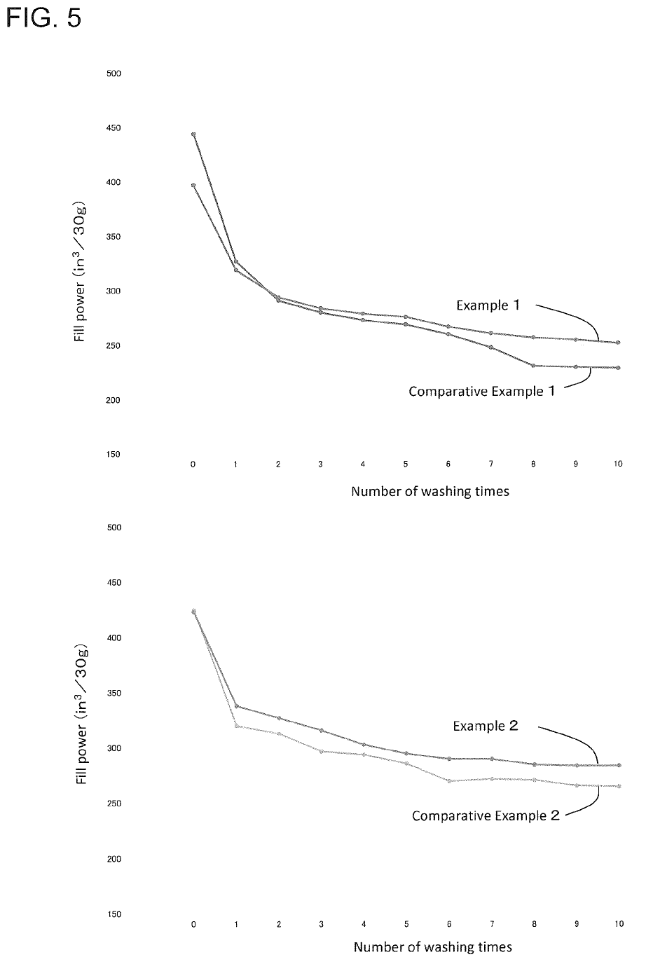

Next, the fiber balls obtained in Examples 1 and 2 and Comparative Examples 1 to 3 were placed in a 30 cm×30 cm plain weave (taffeta) bag made of PET and subjected to a C4M method washing in accordance with JIS L 1930. The fill power (in³/30 g) of the fiber balls after being hung and dried was calculated in the same manner. Washing and measurement were repeated 10 times. The results for Examples 1 and 2 and Comparative Examples 1 and 2 are shown in FIG. 5.

As shown in FIG. 5, the blended fiber balls obtained in Examples 1 and 2 have better bulkiness than the blended fiber balls in which the same proportion of the general rayon was used (Comparative Examples 1 and 2). It can be seen that even after repeated washing, the blended fiber balls obtained in Examples 1 and 2 maintain the bulkiness compared to the corresponding blended fiber balls of Comparative Examples 1 and 2, respectively.

Next, regarding the calculated fill power, a fill power (FP0) of unwashed blended wadding, a fill power (FP1) after washing one time and its ratio (FP1/FP0), and a fill power (FP10) after washings ten times and its ratio (FP10/FP0) were calculated. The results are shown in Table 1.

TABLE 1

| | | | Comparative | Comparative | Comparative |
|---|---|---|---|---|---|
| | Example 1 | Example 2 | Example 1 | Example 2 | Example 3 |
| FP0 | 397 | 423 | 444 | 425 | 488 |
| (in³/30 g) | | | | | |
| FP1 | 319 | 338 | 327 | 320 | 392 |
| (in³/30 g) | | | | | |
| FP10 | 252 | 284 | 229 | 265 | 323 |
| (in³/30 g) | | | | | |
| FP1/FP0 | 80.4 | 79.9 | 73.6 | 75.3 | 80.3 |
| (%) | | | | | |
| FP10/FP0 | 63.5 | 67.1 | 51.6 | 62.4 | 66.2 |
| (%) | | | | | |

From the test results in Table 1 and FIG. 5, it can be seen that in the blended fiber balls of Examples 1 and 2, the fill power is maintained at 76% or more after washing once compared to the fill power of 100% when unwashed, and the fill power is maintained at 63% or more even after washing ten times. On the other hand, in the blended fiber balls of Comparative Examples 1 and 2, although the unwashed fill power is relatively high, it becomes less than 76% after washing once compared to the unwashed fill power of 100%. Further, the fill power after washing ten times was less than 63%, indicating that the fill power decreases more as the number of washing times increases. In the blended fiber balls of Examples 1 and 2, a content of the water-repellent rayon is 30% by mass and 20% by mass, respectively. When the blending ratio of the water-repellent rayon is higher than this, the fill power tends to decrease as a whole regardless of the number of washing times. However, it is considered that the rate of decrease in fill power itself after washing (in other words, the degree of slope of the curve shown in FIG. 5) does not change significantly.

Next, using the same blended fiber balls, a fill power (hereinafter sometimes referred to as Fill Power-R or FP-R) after repeated loading was measured to confirm bulk recovery property.

(Recovery Fill Power after Repeated Loading: Fill Power-R or FP-R)

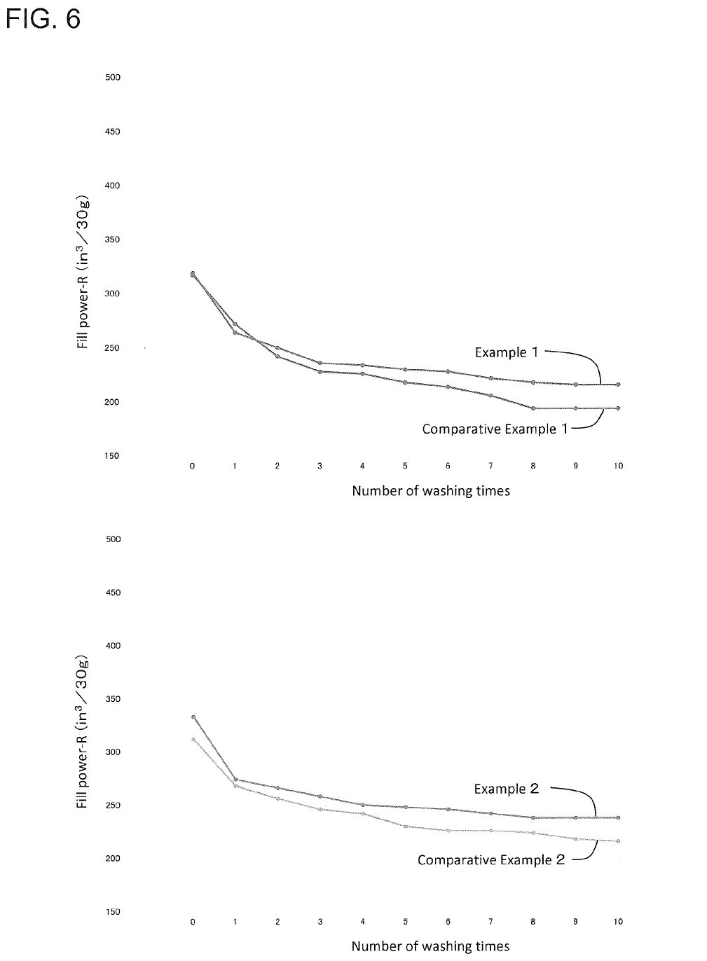

30 g of the blended fiber ball was placed in the same cylinder as used for the fill power (FP) measurement described above. Next, it is left at rest for 60 seconds with a loading disk of 94.3 g put on it. Thereafter, it was left at rest for 30 seconds with a load of 500 g. Then the load of 500 g was removed, and it was left at rest for 30 seconds. After repeating this three times, the load of 500 g was removed, the height at which the blended fiber ball in the cylinder contacts with the loading disk was read, and the fill power-R (in³/30 g) was calculated. Next, the above-mentioned C4M method washing was performed, and the fill power-R (In³/30 g) of the blended fiber ball after being hung and dried was determined under the above-mentioned conditions using a load of 500 g. The results are shown in FIG. 6.

As shown in FIG. 6, even when a load is applied, the behavior is the same as when no load is applied, and it can be seen that the blended fiber balls obtained in Examples 1 and 2 are excellent in both bulkiness and bulk recovery property. On the other hand, it can be seen that the blended fiber balls obtained in Comparative Examples 1 and 2 show relatively high fill power-R before washing and after washing once, but the fill power-R decreases significantly as the number of washing times increases. Generally, washing is performed repeatedly. Therefore, even if it shows a high fill power-R after washing once, it cannot be used as a product if the fill power-R decreases significantly as the number of washing times increases. For example, it can be seen that after the fifth washing, the fill power-R of the blended fiber balls of Examples 1 and 2 is maintained well compared to those of Comparative Examples 1 and 2.

### Example 3

A sheet-like blended padding (hereinafter sometimes referred to as “blended padding sheet”) containing a polyester fiber and a water-repellent regenerated cellulose fiber was prepared. As the polyester fiber, a polyethylene terephthalate (PET) fiber (manufactured by Toray Industries, Inc., raw fiber product number F071, hollow) sterically crimped having a fineness of 6.6 dtex and a fiber length of 64 mm and a polyethylene terephthalate (PET) fiber with a low melting point having a fineness of 2.2 dtex and a fiber length of 51 mm were used. As the water-repellent regenerated cellulose fiber, a water-repellent rayon (having a fineness of 1.7 dtex and naturally crimped) prepared in the same manner as in Reference Example 1 except that the fiber length was 51 mm was used.

Each of the opened fibers was weighed so that the mass ratio of the PET fiber, the PET fiber with the low melting point, and the water-repellent rayon was 50:10:40 and a basis weight of the sheet was 80 g/m². Then, each fiber was put into the wadding storage room 51 (internal volume: 5 m³) and agitated and mixed. Then, the fibers were opened in three roller card machines 42, 43, and 44 to obtain webs W1, W2, and W3, which were stacked as shown in FIG. 2B. After stacking, they were heated to melt the PET fiber with the low melting point to obtain a blended padding sheet having a width of 1.5 m.

### Comparative Example 4

A blended padding sheet was obtained in the same manner as in Example 3, except that a general rayon (manufactured by Daiwabo Rayon Co., Ltd., having a fineness of 1.7 dtex, a fiber length of 51 mm, naturally crimped) was used instead of the water-repellent rayon.

### Comparative Example 5

A blended padding sheet was obtained in the same manner as in Comparative Example 4, except that the mass ratio of the PET fiber, the PET fiber with the low melting point, and the general rayon was 60:10:30.

### Comparative Example 6

A blended padding sheet was obtained in the same manner as in Comparative Example 4, except that the mass ratio of the PET fiber, the PET fiber with the low melting point, and the general rayon was 70:10:20.

### Comparative Example 7

A blended padding sheet was obtained in the same manner as in Comparative Example 4, except that the mass ratio of the PET fiber and the PET fiber with the low melting point was 90:10.

Specific volumes of the blended padding sheets obtained in Example 3 and Comparative Examples 4 to 7 were calculated.

### (Specific Volume)

A blended padding sheet (a thickness: approximately 1.5 cm) was cut into pieces with 20 cm in a length and 20 cm in a width, and four sheets were stacked to prepare a sample. The sample weighed 13.6 g. A thick plate (20 cm×20 cm flat plate, 33 g) was placed on the sample and left at rest for 30 seconds. 30 seconds after placing the thick plate, the heights of the four corners were measured with the thick plate placed on it, and an average value was taken as a thickness. The specific volume was calculated from the thickness and basis weight.

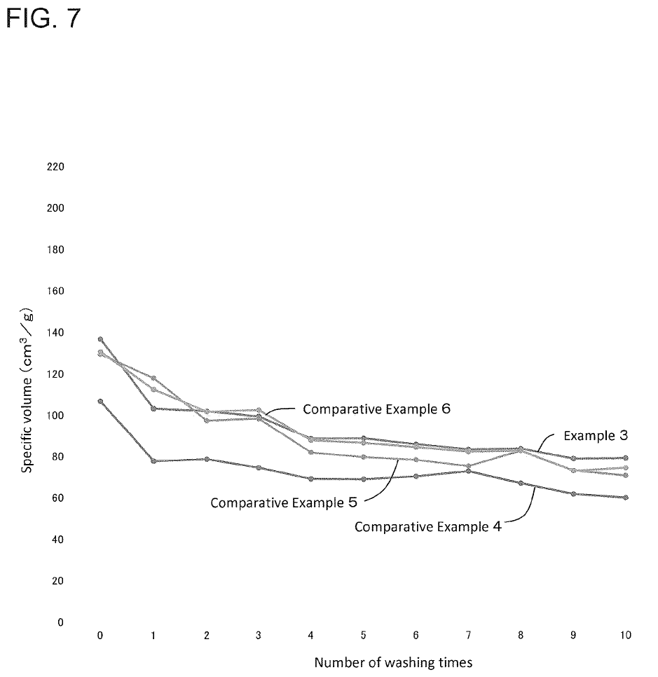

Next, the test pieces of the blended padding sheets obtained in Example 3 and Comparative Examples 4 to 7 were placed in a 30 cm×30 cm plain weave (taffeta) bag made of PET and washed by using a C4M method washing in accordance with JIS L 1930. Hanging and drying was performed, four dried test pieces were stacked to prepare a sample, and a specific volume was calculated in the same manner. The washing and test were repeated ten times. These results are shown in FIG. 7.

As shown in FIG. 7, the blended padding sheet obtained in Example 3 maintains a specific volume of 75 cm 3/g or more even after repeated washing. Therefore, it can be seen that the blended padding sheet obtained in Example 3 has a larger specific volume than the blended padding sheet in which the general rayon is used (Comparative Examples 4 to 6) and has a good bulkiness. Furthermore, when comparing Example 3 and Comparative Example 6, it can be seen that even if the blending ratio of polyester is increased as in the Comparative Example, similar specific volumes can be obtained. It is presumed that this is because the use of water-repellent rayon, which has both washing durability and moisture absorption, suppresses the decrease in specific volume after washing.

Example 3 is an example including 60% by mass of the PET fiber. It is estimated that if the proportion of the PET fiber is increased by using a water-repellent rayon as in Comparative Examples 5 and 6 (70% and 80% by mass of the PET fiber, respectively), the specific volume will be larger than that in Example 3.

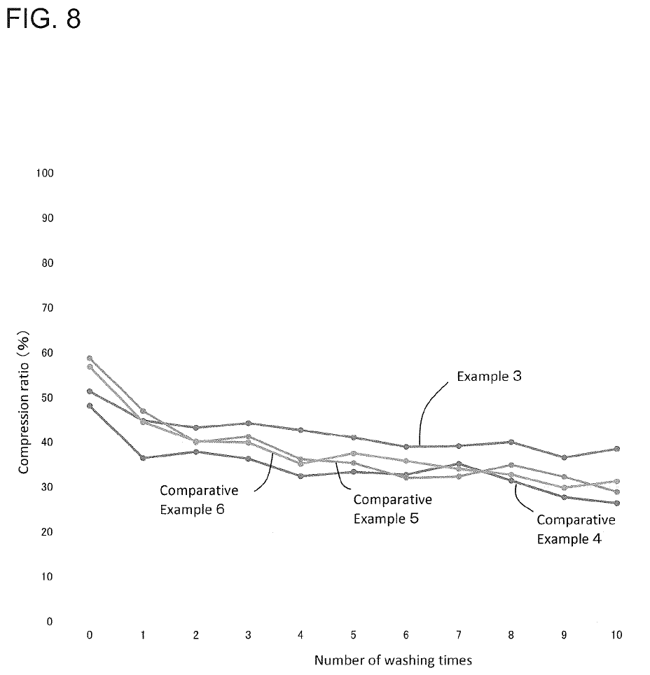

Next, a compression ratio was calculated by using the method described above. The results are shown in FIG. 8. As shown in FIG. 8, the blended padding sheet obtained in Example 3 has a higher compression ratio and a larger sunk amount than the blended padding sheet in which the same proportion of the general rayon is used (Comparative Example 4). That is, it can be seen that the material has excellent fluffy bulk property (bulk elasticity). Similar behavior was observed even after repeated washing. Compared to the blended padding sheet including 30% by mass of the general rayon (Comparative Example 5) and the blended padding sheet including 20% by mass of the general rayon (Comparative Example 6), it can be seen that the results obtained in Example 3, especially after repeated washing, have a large compression ratio of 35% or more, and the difference is remarkable.

Then, for the blended padding sheets obtained in Example 3 and Comparative Examples 4 to 7, a ratio (H1/H0) of a compression rate (H1) after washing once to a compression rate (H0) of the unwashed blended padding sheet was calculated. As mentioned above, the washing is performed by the C4M method washing in accordance with JIS L 1930. The results are shown in Table 2.

TABLE 2

| | | Comparative | Comparative | Comparative | Comparative |
|---|---|---|---|---|---|
| | Example 3 | Example 4 | Example 5 | Example 6 | Example 7 |
| Compression | 51% | 48% | 59% | 57% | 57% |
| ratio (H0) of | | | | | |
| unwashed | | | | | |
| blended | | | | | |
| padding | | | | | |
| Compression | 45% | 36% | 47% | 45% | 54% |
| ratio (H1) | | | | | |
| after washing | | | | | |
| once | | | | | |
| Compression | 38% | 26% | 29% | 31% | 45% |
| ratio (H10) | | | | | |
| after washing | | | | | |
| ten times | | | | | |
| H1/H0 | 88.2% | 75% | 79.7% | 78.9% | 94.7% |
| H10/H0 | 74.5% | 54.2% | 49.2% | 54.4% | 78.9% |

As shown in Table 2, in the blended padding sheet obtained in Example 3, the ratio (H1/H0) of the compression ratio (H1) after washing once to the compression ratio (H0) of the unwashed blended padding sheet is 88.28, indicating that it has good bulk even when used under load conditions after washing, that is, the bulk property (bulk elasticity) is maintained even after washing, and good heat retention can be obtained. Furthermore, even after washing ten times, H10/H0 is 55% or more, indicating that sufficient bulk property (bulk elasticity) is maintained.

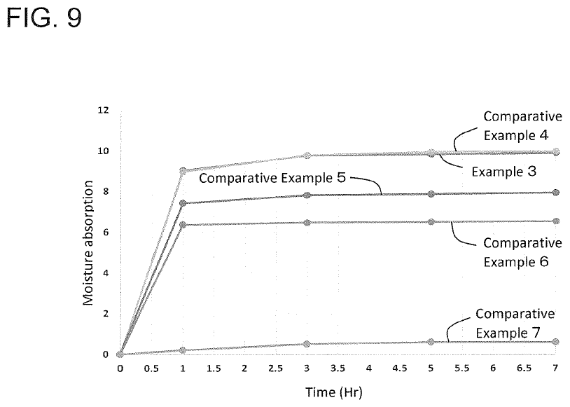

Next, moisture absorption and release properties of the blended padding sheets obtained in Example 3 and Comparative Examples 4 to 6 were verified in accordance with the procedure of Reference Example 2. First, the blended padding sheets obtained in Example 3 and Comparative Examples 4 to 6 were cut into pieces in a length of 10 cm and a width of 10 cm to obtain samples. A mass of the obtained sample in an absolute dry state was measured. This mass is defined as W0. Next, the sample was left at rest for 7 hours at 40° C. under a condition of 90% RH to absorb moisture. The mass of the sample was measured every 30 minutes from the start of moisture absorption. This mass is defined as W. From the obtained masses W0 and W, the moisture absorption (moisture content) was calculated by using the above formula (II). The results are shown in FIG. 9.

As shown in FIG. 9, the blended padding sheet obtained in Example 3 had the moisture absorption of 3% or more after one hour had passed from the start of moisture absorption, indicating that it exhibits the same moisture absorption property as the blended padding sheet in which the same proportion of the general is used (Comparative Example 4). Therefore, it can be seen that the blended padding (blended fiber ball, blended padding sheet or the like) including the water-repellent rayon of the present disclosure has excellent moisture absorption as well as the general rayon. On the other hand, it can be seen that Comparative Example 7 in which only polyester fiber is included exhibits almost no moisture absorption.

As described above, the blended padding including the water-repellent rayon fiber and the polyester fiber of the present disclosure has comparable moisture absorption with better bulk property after washing, especially after repeated washing, compared to the blended padding in which the same proportion of the general rayon fiber is used. Furthermore, it has superior moisture absorption compared to the padding in which only polyester fiber is included. That is, it can be seen that the blended padding of the present disclosure is a padding having both bulk property and moisture absorption properties with good washing durability.

### DESCRIPTION OF THE REFERENCE NUMERALS

2 carding machine
4 opened fiber storage chamber
5, 51 wadding storage room
8 suction port
9 blended wadding storage chamber
10, 11, 12 feed lattice
20 ball machine
21 storage chamber
30, 31, 32 wadding transfer means
42, 43, 44 roller card machine
W1, W2, W3 web

1. A blended padding comprising a polyester fiber and a water-repellent regenerated cellulose fiber, wherein
the water-repellent regenerated cellulose fiber comprises a compound containing at least one acidic group selected from the group consisting of a carboxyl group and a sulfonic acid group, the fiber surface is bonded with a cross-linking agent and a hydrocarbon-based water repellent containing a polymer having (meth)acrylic ester as a basic unit of a monomer, and
the polyester fiber and the water-repellent regenerated cellulose fiber are included in a mass ratio of 30:70 to 90:10.

2. The blended padding according to claim 1, wherein the water-repellent regenerated cellulose fiber comprises a water-repellent rayon.

3. The blended padding according to claim 1, wherein the polyester fiber comprises at least one fiber selected from the group consisting of a polyethylene terephthalate (PET) fiber, a polytrimethylene terephthalate (PTT) fiber, a polybutylene terephthalate (PBT) fiber, a polyethylene naphthalate fiber (PEN), a polylactic acid (PLA) fiber, a polycaprolactone (PCL) fiber and a polybutylene succinate (PBS) fiber.

4. The blended padding according to claim 1 having a form of a blended fiber ball, a blended padding sheet or an opened fiber.

5. The blended padding according to claim 4, wherein at least one of the requirements that a ratio (FP1/FP0) of a fill power (FP1) after washing once to a fill power (FP0) of unwashed blended fiber ball is 76% or more, and a ratio (FP10/FP0) of a fill power (FP10) after washing ten times to the fill power (FP0) of the unwashed blended fiber ball is 63% or more is satisfied when the blended fiber ball is washed by a C4M method in accordance with JIS L 1930.

6. The blended padding according to claim 4, wherein a compression ratio of the blended padding sheet after washing ten times measured by the following formula (III)′ is 32% or more;
Compression ratio (%)={(Ha−Hb)/Ha}×100 (III)′
Ha: An average value of heights of the four corners measured as follows. Stacking four blended padding sheets each having a square shape of 20 cm on a side, and placing a thick plate of 33 g having a square shape of 20 cm on a side on top of the sheets and leaving it at rest for 30 seconds, and thereafter, measuring the heights of the four corners with the thick plate placed thereon, and calculating an average value.
Hb: An average value of heights of the four corners measured as follows. After measuring Ha, placing a weight of 500 g on the thick plate and leaving it at rest for 30 seconds, and thereafter, measuring the heights of the four corners with the thick plate and the weight placed thereon, and calculating an average value.
Washing: A C4M method washing in accordance with JIS L 1930.

7. The blended padding according to claim 4, wherein at least one of the requirements that a ratio (H1/H0) of a compression ratio (H1) after washing once to a compression ratio (H0) of unwashed blended padding sheet is 80% or more, and a ratio (H10/H0) of a compression ratio (H10) after washing ten times to the compression ratio (H0) of the unwashed blended padding sheet is 55% or more is satisfied when the blended padding sheet is washed by a C4M method in accordance with JIS L 1930.

8. The blended padding according to claim 4, wherein moisture absorption calculated from a mass W0 in an absolute dry state and a mass W after being left at rest at 40° C. under a condition of 90% RH to absorb moisture is 3% or more at least after 1 hour and after 7 hours of being left at rest.

9. A padding material for clothing or bedding comprising a blended padding according to claim 1.

10. A clothing whose interior is filled with a blended padding according to claim 1.

11. A bedding whose interior is filled with a blended padding according to claim 1.
